(19) United States
(12) Patent Application Publication
(10) Pub. No.: US 2005/0151714 A1
(43) Pub. Date: Jul. 14, 2005

(54) Output circuit, liquid crystal driving circuit, and liquid crystal driving method

(76) Inventor: Atsushi Hirama, Tokyo (JP)

Correspondence Address: VOLENTINE FRANCOS, PLLC, Suite 150, 12200 Sunrise Vally Drive, Reston, VA, 20191, US

(21) Appl. No.: 10/873,266

(22) Filed: Jun. 23, 2004

(30) Foreign Application Priority Data
Jan. 13, 2004 (JP) 2004-005739

(51) Int. Cl. G09G 3/36

(52) U.S. Cl. 345/100

(57) ABSTRACT

An output circuit for driving a signal line in, for example, a liquid crystal display panel has an impedance conversion element that generates an output signal from an input signal and a feedback signal. During output periods, a first switch conducts the output signal to the output terminal of the output circuit and a second switch conducts the output signal from the output terminal back to the impedance element as the feedback signal. During non-output periods, the first and second switches are switched off and a third switch conducts the output signal back to the impedance element as the feedback signal from a point between the impedance conversion element and the first switch. This dual feedback scheme enables the signal line to be precharged during non-output periods while avoiding loss of driving speed and accuracy during output periods.

### BACKGROUND OF THE INVENTION

1. Field of the Invention

The present invention relates to an output circuit employing feedback control, a liquid crystal driving circuit that uses the output circuit to drive a liquid crystal panel, and a liquid crystal driving method that uses the output method of the output circuit to drive a liquid crystal panel.

2. Description of the Related Art

As disclosed in Japanese Unexamined Patent Application Publication No. 11-30975, the driving speed of a liquid crystal display panel having source lines driven by operational amplifiers can be increased by precharging the source lines. The source lines are precharged by disconnecting them from their drivers (the operational amplifiers) and either interconnecting the source signal lines, or connecting them to a fixed potential such as the common-voltage potential of the liquid crystal display panel.

FIG. 8 illustrates the former precharging scheme in a conventional liquid crystal display including a liquid crystal panel 1, a gate driving circuit 2, a source driving circuit 3, a group of m source lines S₁, S₂, . . . , Sₘ, and a group of n gate lines G₁, G₂, . . . , Gₘ, where m and n are positive integers, m being equal to or greater than two. The liquid crystal panel 1 includes cell transistors TRᵢⱼ and capacitors CXᵢⱼ (1≦i≦m, 1≦j≦n). The gate driving circuit 2 includes gate drivers GDⱼ (1≦j≦n).

Referring to FIG. 9, the source driving circuit 3 comprises m source drivers SD₁, SD₂, . . . , SDₘ, connected through respective analog switches A₁, A₂, . . . , Aₘ to respective output terminals OUT₁, OUT₂, . . . , OUTₘ, a group of m-1 analog switches D₁, D₂, . . . , Dₘ₋₁ by which mutually adjacent source lines are switchably interconnected, and an inverter I. A single output circuit comprises a source driver SDᵢ, the corresponding analog switches Aᵢ, Dᵢ, and output terminal OUTᵢ (where i is an arbitrary integer from 1 to m). The source driver SDᵢ is an operational amplifier receiving a source driving signal SSᵢ as its non-inverting input, generating a corresponding output signal for driving source line Sᵢ, and feeding the output signal back as its inverting input. Feedback ensures that the output signal has the same potential as the source driving signal SSᵢ. Various other impedance conversion means controlled by feedback can also be used as the source driver SDᵢ.

Analog switches A₁ to Aₘ and D₁ to Dₘ₋₁ are controlled by a switch control signal PC input to inverter I and a complementary switch control signal PCB output from inverter I. When switch control signal PC is ‘0’ and PCB is ‘1’, analog switches A₁ to Aₘ all turn on and analog switches D₁ to Dₘ₋₁ all turn off, so that output terminals OUT₁ to OUTₘ (and source lines S₁ to Sₘ) are connected to the output terminals of respective source drivers SD₁ to SDₘ and the output signals from the source drivers SD₁ to SDₘ are output on source lines S₁ to Sₘ. When switch control signal PC goes to ‘1’ and switch control signal PCB goes to ‘0’, analog switches A₁ to Aₘ all turn off and analog switches D₁ to Dₘ₋₁ all turn on, disconnecting output terminals OUT₁ to OUTₘ (and source lines S₁ to Sₘ) from the source drivers SD₁ to SDₘ and interconnecting all of the output terminals and source lines; the output terminals and source lines are thereby precharged. When switch control signal PC returns to ‘0’ and switch control signal PCB returns to ‘1’, analog switches A₁ to Aₘ all turn on and analog switches D₁ to Dₘ₋₁ all turn off, disconnecting output terminals OUT₁ to OUTₘ (and source lines S₁ to Sₘ) from each other and connecting them to the source drivers SD₁ to SDₘ.

Although the purpose of this precharging scheme is faster driving, to enable the source drivers to receive feedback during the precharging period, the feedback signals must be taken from points between the source drivers and the analog switches A₁ to Aₘ. Consequently, during driving periods, the source drivers must drive the on-resistance of these analog switches as well as the capacitance of the capacitors in the liquid crystal panel. Because of the voltage drop due to the on-resistance of the analog switches, the potentials of the output terminals of the source driving circuit 3 differ from the potentials of the signals output by the source drivers. Although the potential difference diminishes and eventually disappears as the capacitors approach and eventually reach the intended charge level, the potential difference slows the approach, thereby limiting the speed with which the liquid crystal panel can be driven. A further problem is that variations in wiring resistance due to variations in the on-resistance of the analog switches and the wiring length of the output paths create unwanted variations in driving potential among the output terminals (and source lines), impairing the accuracy with which the liquid crystal panel 1 is driven, leading to lowered image quality. As the number of pixels increases and the driving frequency increases, driving the liquid crystal panel accurately at the necessary speed becomes a significant challenge.

### SUMMARY OF THE INVENTION

An object of the present invention is to provide an output circuit in which an impedance conversion element, switchably connectable to an output terminal, can rapidly generate an output signal at the correct potential level at the output terminal.

A further object is to provide a circuit and method for rapidly and accurately driving a liquid crystal display panel.

The impedance conversion element in the invented output circuit generates an output signal from an input signal and a feedback signal. An output path conducts the output signal from the impedance conversion element to the output terminal of the output circuit. The output path includes a first switch that conducts the output signal during output periods and blocks the output signal during non-output periods. A second switch conducts the output signal from a first point on the output path to the impedance conversion element as the feedback signal during the output periods. A third switch conducts the output signal from a second point on the output path to the impedance conversion element as the feedback signal during the non-output periods. The first point is disposed at the output terminal, or between the first switch and the output terminal; the second point is disposed between the impedance conversion element and the first switch.

The second switch provides feedback of the potential at the output terminal to the impedance conversion element. By comparing the feedback signal with the input signal, the impedance conversion element can quickly and accurately adjust its output so that the desired potential is obtained at the output terminal of the output circuit.

Output circuits of the invented type can be used to drive a liquid crystal display panel accurately at high speed. The output terminals and their connected signal lines can be precharged during the non-output periods.

### BRIEF DESCRIPTION OF THE DRAWINGS

In the attached drawings:

FIG. 1 is a circuit diagram of a liquid crystal display according to a first embodiment of the invention;

FIG. 2 is a more detailed circuit diagram of the source driving circuit in FIG. 1;

FIG. 3 is a timing waveform diagram illustrating the operation of the source driving circuit;

FIG. 4 is a waveform diagram comparing simulated output waveforms in the first embodiment and prior art;

FIG. 5 is a circuit diagram of the source driving circuit in a second embodiment;

FIG. 6 is a circuit diagram of the source driving circuit in a third embodiment;

FIG. 7 is a timing waveform diagram illustrating the operation of the source driving circuit in the third embodiment;

FIG. 8 is a circuit diagram of a liquid crystal display according to the prior art; and

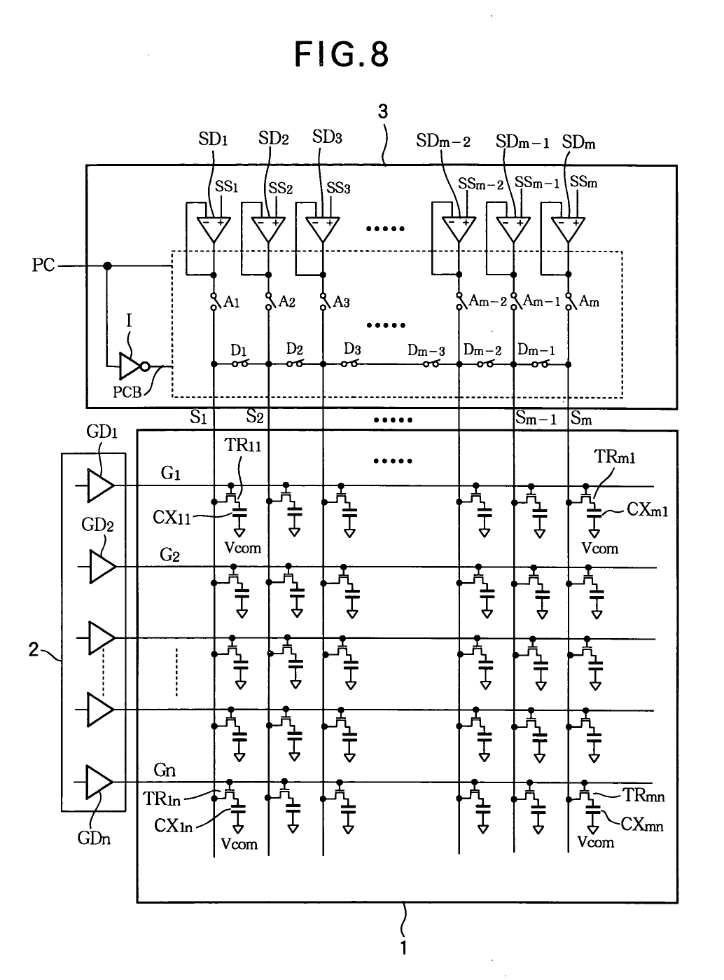

FIG. 9 is a more detailed circuit diagram of the source driving circuit in FIG. 8.

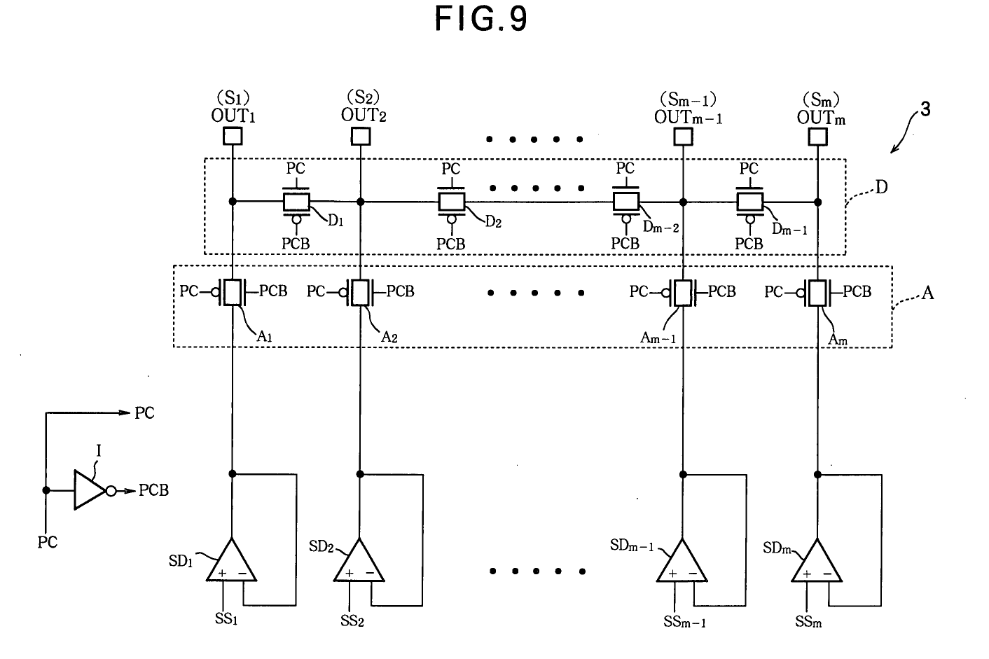

### DETAILED DESCRIPTION OF THE INVENTION

Embodiments of the invention will now be described with reference to the attached drawings, in which like elements are indicated by like reference characters.

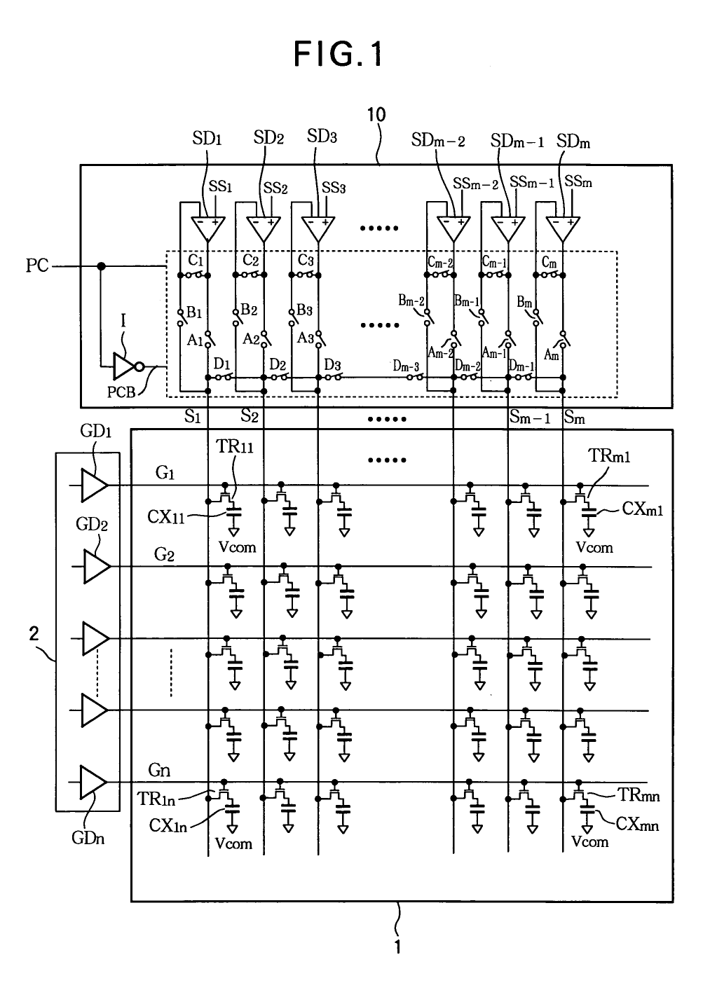

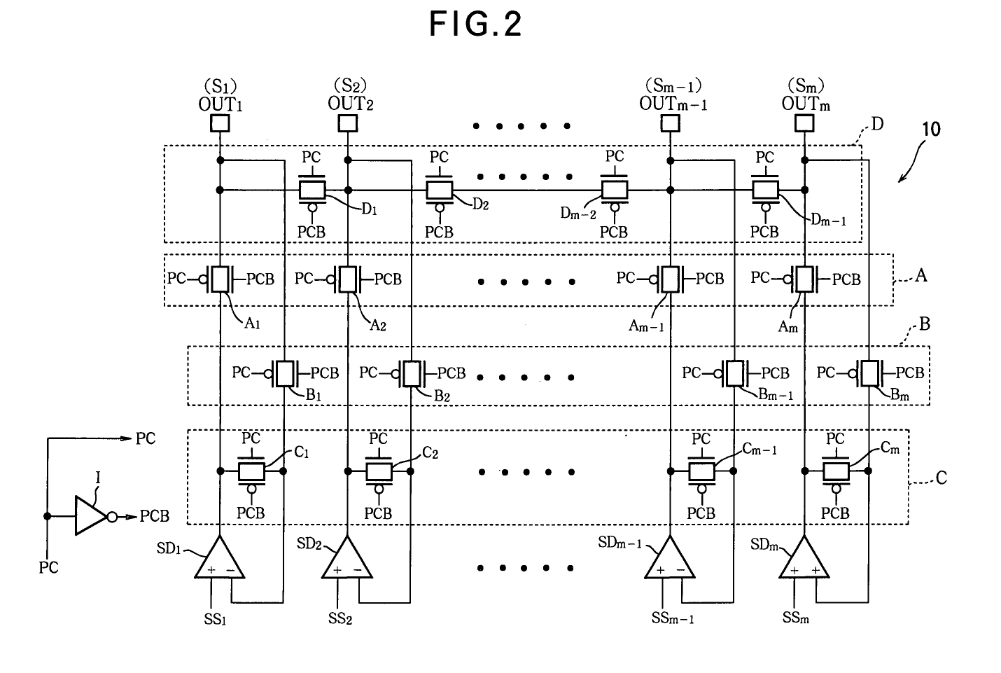

Referring to FIG. 1, a liquid crystal display according to a first embodiment of the invention comprises a liquid crystal panel 1, a gate driving circuit 2, a source driving circuit 10, a group of source lines, and a group of gate lines. FIG. 2 shows the circuit configuration of the source driving circuit 10 in more detail.

The group of source lines comprises m source lines S₁, S₂, . . . , Sₘ (where m is an arbitrary integer equal to or greater than two); the group of gate lines comprises n gate lines G₁, G₂, . . . , Gₙ (where n is an arbitrary integer equal to or greater than two). The source lines and gate lines form a set of matrix lines for driving an m×n matrix of liquid crystal cell switching transistors.

The liquid crystal panel 1 comprises the m×n switching transistors TR₁₂, TR₂₂, . . . , Tₘₙ and m×n liquid crystal cell capacitors CX₁₁, CX₂₁, . . . , CXₘ₁, CX₁₂, CX₂₂, . . . , CXₘₙ. Switching transistor TRᵢⱼ and liquid crystal cell capacitor CXᵢⱼ form a liquid crystal cell (i is an integer from 1 to m; j is an integer from 1 to n). The liquid crystal panel 1 has a matrix of m×n liquid crystal cells.

The source and drain of switching transistor TRᵢⱼ are connected between source line Sᵢ and the cell electrode of liquid crystal cell capacitor CXᵢⱼ; the gate of TRᵢⱼ is connected to gate line Gⱼ. The common electrode of liquid crystal cell capacitor CXᵢⱼ is connected to a common power source V_{com}.

The gate driving circuit 2 has n gate drivers GD₁, GD₂, . . . , GDₙ. The gate driving circuit 2 uses gate driver GDⱼ to drive gate line Gⱼ.

As shown in FIGS. 1 and 2, the source driving circuit 10 in the first embodiment comprises the m source drivers SD₁, SD₂, . . . , SDₘ, an A-group of analog switches (A₁ etc.) that control output paths, a B-group of analog switches (B₁ etc.) that control first feedback paths, a C-group of analog switches (C₁ etc.) that control second feedback paths, a D-group of analog switches (D₁ etc.) that control precharging, a group of m output terminals OUT₁, OUT₂, . . . , OUTₘ, and an inverter I. Each analog switch comprises a p-channel metal-oxide-semiconductor (PMOS) transistor and an n-channel metal-oxide-semiconductor (NMOS) transistor connected in parallel, as can be seen in FIG. 2.

The i-th source driver SDᵢ is an operational amplifier with a non-inverting input terminal to which a source driving signal SS₁ is input, an output terminal from which a signal is output to drive the i-th source line Sᵢ to the potential of the input source driving signal SS₁, and an inverting input terminal to which the output signal is fed back. The source driver SDᵢ operates as a voltage-follower buffer amplifier with high-impedance input and low-impedance output.

The invention is not limited to the use of operational amplifiers. Various types of impedance conversion means including a buffer or amplifier can be used as the source driver SDᵢ.

The A-group of analog switches comprises m analog switches (MOS switches) A₁, A₂, . . . , Aₘ. Analog switch Aᵢ is connected between the output terminal of the i-th source driver SDᵢ and the i-th output terminal OUTᵢ of the source driving circuit 10, thus between the output terminal of source driver SDᵢ and source line Sᵢ. The gate electrode of the PMOS transistor in analog switch Aᵢ receives a switch control signal PC (the input signal to the inverter I); the gate electrode of the NMOS transistor in analog switch Aᵢ receives a complementary switch control signal PCB (the output signal from the inverter I). Analog switch Aᵢ turns off if switch control signal PC is at the logical ‘1’ level (PC=1, PCB=0), thereby disconnecting the output terminal of source driver SDᵢ from output terminal OUTᵢ (source line Sᵢ); analog switch Aᵢ turns on if PC is at the logical ‘0’ level (PC=0, PCB=1), thereby connecting the output terminal of source driver SDᵢ to output terminal OUTᵢ (source line Sᵢ). This embodiment assumes that the logical ‘0’ level is low and the logical ‘1’ level is high.

The B-group of analog switches comprises m analog switches (MOS switches) B₁, B₂, . . . , Bₘ. Analog switch Bᵢ is connected between the i-th output terminal OUTᵢ (source line Sᵢ) of the source driving circuit 10 and the inverting input terminal of source driver SDᵢ. The gate electrode of the PMOS transistor in analog switch Bᵢ receives switch control signal PC; the gate electrode of the NMOS transistor in analog switch Bᵢ receives switch control signal PCB. Analog switch Bᵢ turns off when PC=1 (PCB=0), thereby disconnecting the inverting input terminal of source driver SDᵢ from output terminal OUTᵢ (and source line Sᵢ); analog switch Bᵢ turns on when PC=0 (PCB=1), thereby connecting the inverting input terminal of source driver SDᵢ to output terminal OUTᵢ (and source line Sᵢ).

The C-group of analog switches comprises m analog switches (MOS switches) C₁, C₂, . . . , Cₘ. Analog switch Cᵢ is connected between the output and inverting input terminals of source driver SDᵢ. The gate electrode of the PMOS transistor in analog switch Cᵢ receives switch control signal PCB; the gate electrode of the NMOS transistor in analog switch Cᵢ receives switch control signal PC. Analog switch Cᵢ turns on if switch control signal PC=1 (PCB=0), thereby connecting the output terminal of source driver SDᵢ to the inverting input terminal of source driver SDᵢ; analog switch Cᵢ turns off if switch control signal PC=0 (PCB=1), thereby disconnecting the output terminal of source driver SDᵢ from the inverting input terminal of source driver SDᵢ.

The D-group of analog switches comprises m-1 analog switches (MOS switches) D₁, D₂, . . . , Dₘ₋₁ (there is no Dm) The i-th analog switch Dᵢ is connected between the i-th output terminal OUTᵢ and the (i+1)-th output terminal OUTᵢ₊₁ of the source driving circuit 10, thus between source line Sᵢ and source line Sᵢ₊₁. The gate electrode of the PMOS transistor in analog switch Dᵢ receives switch control signal PCB; the gate electrode of the NMOS transistor in analog switch Dᵢ receives switch control signal PC. Analog switch Dᵢ turns on if switch control signal PC=1 (PCB=0), thereby establishing a short circuit between source line Sᵢ and source line Sᵢ₊₁ through output terminals OUTᵢ and OUTᵢ₊₁ of the source driving circuit; analog switch Dᵢ turns off if switch control signal PC=0 (PCB=1), thereby breaking the short circuit that has been established between source lines Sᵢ and Sᵢ₊₁ (and between the corresponding output terminals of the source driving circuit). In the first embodiment, a source line (and the corresponding output terminal of the source driving circuit) is precharged from other source lines (and other output terminals of the source driving circuit).

In the source driving circuit 10 of the first embodiment, source driver SDᵢ, analog switches Aᵢ, Bᵢ, Cᵢ, and Dᵢ, and output terminal OUTᵢ form an output circuit.

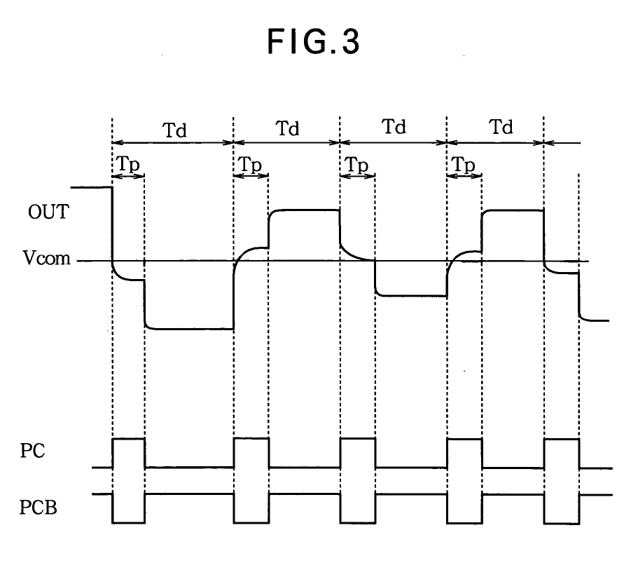

The operation of the source driving circuit 10 in the first embodiment will be described below with reference to FIG. 3, which shows waveforms of an output signal OUT of the source driving circuit 10 (the signal output from output terminal OUTᵢ to source line Sᵢ), the switch control signal PC, and the complementary switch control signal PCB. T_{d} indicates the dot driving cycle time of the liquid crystal display, including both the driving (output) period and the precharging (non-output period); Tₚ indicates the precharging (non-output) period.

During a precharging period, switch control signal PC is ‘1’ and complementary switch control signal PCB is ‘0’, so the A- and B-group analog switches are all in the off state, while the C- and D-group analog switches are all in the on state.

Since analog switches Aᵢ and Bᵢ are in the off state and analog switches Dᵢ₋₁ and Dᵢ are in the on state, output terminal OUTᵢ (and source line Sᵢ) is disconnected from the output and inverting input terminals of source driver SDᵢ and is connected via analog switches Dᵢ₋₁ and Dᵢ to the adjacent output terminals OUTᵢ₋₁ (source line Sᵢ₋₁) and OUTᵢ₊₁ (source line Sᵢ₊₁). All of the output terminals OUTᵢ and source lines Sᵢ (1≦i≦m) are mutually interconnected in this way, so all of the output terminals OUTᵢ and source lines Sᵢ are precharged to substantially the average output potential in the preceding driving period.

Since analog switch Bᵢ is off and analog switch Cᵢ is on, the output potential of source driver SDᵢ is fed back to the inverting input terminal of source driver SDᵢ via analog switch Cᵢ. Since the input impedance of the inverting input of source driver SDᵢ is extremely high, the potential fed back to the inverting input terminal of source driver SDᵢ becomes equal to the output potential of source driver SDᵢ regardless of the on-resistance in analog switch Cᵢ. Since source driver SDᵢ operates so as to make the potential of its inverting input (the output potential of source driver SDᵢ) equal to the potential of its non-inverting input (source driving signal SSᵢ), the output potential of source driver SDᵢ equals the potential of source driving signal SSᵢ.

At the transition from the precharging period to the driving period, switch control signal PC goes to the ‘0’ logic level and switch control signal PCB goes to the ‘1’ logic level, switching all the C- and D-group analog switches off and all the A- and B-group analog switches on. Analog switches Dᵢ₋₁ and Dᵢ₊₁ accordingly turn off and analog switch Aᵢ turns on, disconnecting output terminal OUTᵢ (source line Sᵢ) from the adjacent output terminals OUTᵢ₋₁ (source line Sᵢ₋₁) and OUTᵢ₊₁ (source line Sᵢ₊₁) and connecting it to the output terminal of source driver SDᵢ via analog switch Aᵢ.

Analog switch Cᵢ turns off and analog switch Bᵢ turns on, switching from the second feedback path to the first feedback path, thereby feeding back the potential of output terminal OUTᵢ (source line Sᵢ) after the voltage drop caused by the on-resistance of analog switch Aᵢ to the inverting input terminal of source driver SDᵢ via analog switch Bᵢ. Since the input impedance at the inverting input terminal of source driver SDᵢ is extremely high, the potential at the inverting input terminal of source driver SDᵢ rapidly becomes equal to the potential of output terminal OUTᵢ (source line Sᵢ). Since source driver SDᵢ operates so as to make the potential of its inverting input (the potential of output terminal OUTᵢ or source line Sᵢ) equal to the potential of its non-inverting input (source driving signal SSᵢ), the potential of output terminal OUTᵢ (source line Sᵢ) rapidly becomes equal to the potential of source driving signal SSᵢ.

At the precharging-to-driving transition, accordingly, the source driving circuit 10 in the first embodiment switches the feedback potential of the i-th output circuit from the potential at a point preceding analog switch Aᵢ to the potential at a point following analog switch Aᵢ, thereby compensating for the voltage drop due to the on-resistance of analog switch Aᵢ so that the potential of output terminal OUTᵢ (source line Sᵢ) quickly becomes equal to the potential of source driving signal SSᵢ (the input potential to source driver SDᵢ). This feedback arrangement also compensates for variations in voltage drop due to variations in on-resistance, resulting in both faster and more accurate driving of the source lines.

This feedback arrangement can also compensate for the voltage drop due to the resistance of the signal line from the output terminal of source driver SDᵢ to the point at which analog switches Aᵢ and Bᵢ are interconnected, which accounts for most of the wiring resistance on the signal path from the output terminal of source driver SDᵢ to output terminal OUTᵢ. This means that, if there are variations in wiring resistance (or wiring length) on the output paths, they can be compensated for completely, or almost completely, by interconnecting the analog switches Aᵢ and Bᵢ at output terminal OUTᵢ or at a point located as near as possible to output terminal OUTᵢ.

During the driving period, switch control signal PC is ‘0’ and switch control signal PCB is ‘1’, so the A- and B-group analog switches are all in the on state and the C- and D-group analog switches are all in the off state.

Analog switches Dᵢ₋₁ and Dᵢ₊₁ are in the off state, and analog switch Aᵢ is in the on state, disconnecting output terminal OUTᵢ (and source line Sᵢ) from the adjacent output terminals OUTᵢ₋₁ and OUTᵢ₊₁ (and source lines Sᵢ₋₁ and Sᵢ₊₁) and connecting it to the output terminal of source driver SDᵢ via analog switch Aᵢ.

Analog switch Cᵢ is in the off state and analog switch Bᵢ is in the on state, feeding the potential of output terminal OUTᵢ (source line Sᵢ) back via analog switch Bᵢ on the first feedback path to the inverting input terminal of source driver SDᵢ, thereby keeping the potential of output terminal OUTᵢ (source line Sᵢ) equal to the potential of the non-inverting input (source driving signal SSᵢ) of source driver SDᵢ.

At the transition from the driving period to the next precharging period, switch control signal PC goes to ‘1’ and switch control signal PCB goes to ‘0’, switching all the A- and B-group analog switches off and all the C- and D-group analog switches on.

Analog switches Aᵢ and Bᵢ turn off and analog switches Dᵢ₋₁ and Dᵢ₊₁ turn on, disconnecting output terminal OUTᵢ (and source line Sᵢ) from the output and inverting input terminals of source driver SDᵢ, and connecting output terminal OUTᵢ to adjacent output terminals OUTᵢ₋₁ and OUTᵢ₊₁ (and source lines Sᵢ₋₁ and Sᵢ₊₁) via analog switches Dᵢ₋₁ and Dᵢ₊₁, thereby precharging source line Sᵢ.

Analog switch Bᵢ turns off and analog switch Cᵢ turns on, changing the feedback path from the first feedback path to the second feedback path, thereby feeding the output potential of source driver SDᵢ back to the inverting input terminal of source driver SDᵢ₋₁ via analog switch Cᵢ.

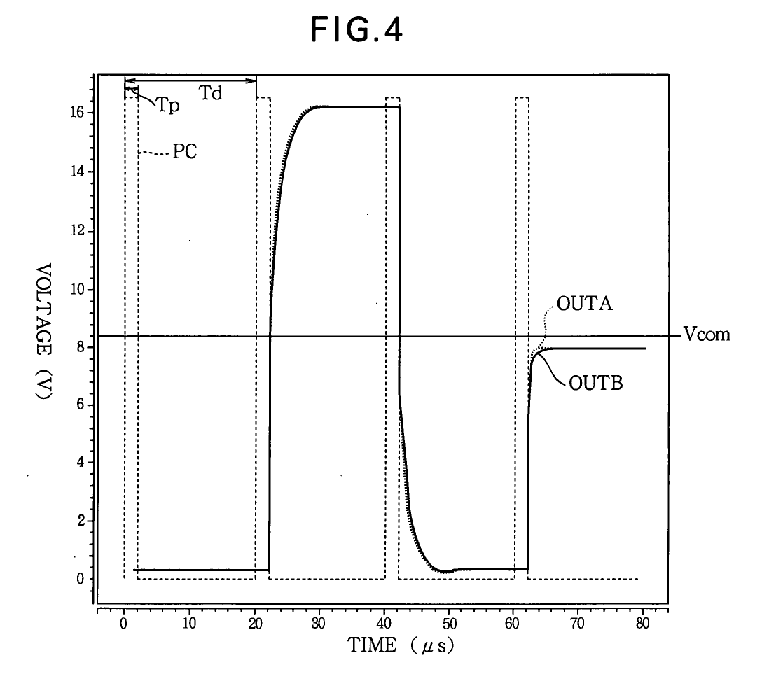

FIG. 4 shows simulated waveforms of the switch control signal PC, an output signal OUTA of the source driving circuit 10 in the first embodiment, and an output signal OUTB of the conventional source driving circuit 3. T_{d} indicates the dot driving cycle time of the liquid crystal display; Tₚ indicates the precharging period. In the simulation shown in FIG. 4, dots are driven alternately positive and negative with respect to the common voltage V_{com}, and for simplicity, all dots are driven to the same potential, so precharging does not alter the potential.

As is evident from FIG. 4, the simulated output waveform OUTA in the first embodiment rises nearly ten percent (10%) faster than the simulated output waveform OUTB in the prior art. This improvement in rise time is particularly noticeable at intermediate driving potentials (potentials near the common voltage V_{com}).

As described above, the first embodiment provides a first feedback path from a point following the A-group analog switch to the source driver during the driving period and a second feedback path from a point preceding the A-group analog switch to the source driver during the precharging period, and switches the feedback path at transitions from the driving period to the precharging period and vice versa, thereby compensating for the voltage drop due to the on-resistance of the analog switch, and further compensating for variations in on-resistance and wiring resistance of the output path. The first embodiment thereby achieves fast and highly accurate liquid crystal driving. By precharging the source lines from adjacent source lines, the first embodiment also conserves power and eliminates the need for a special precharging power source.

### Second Embodiment

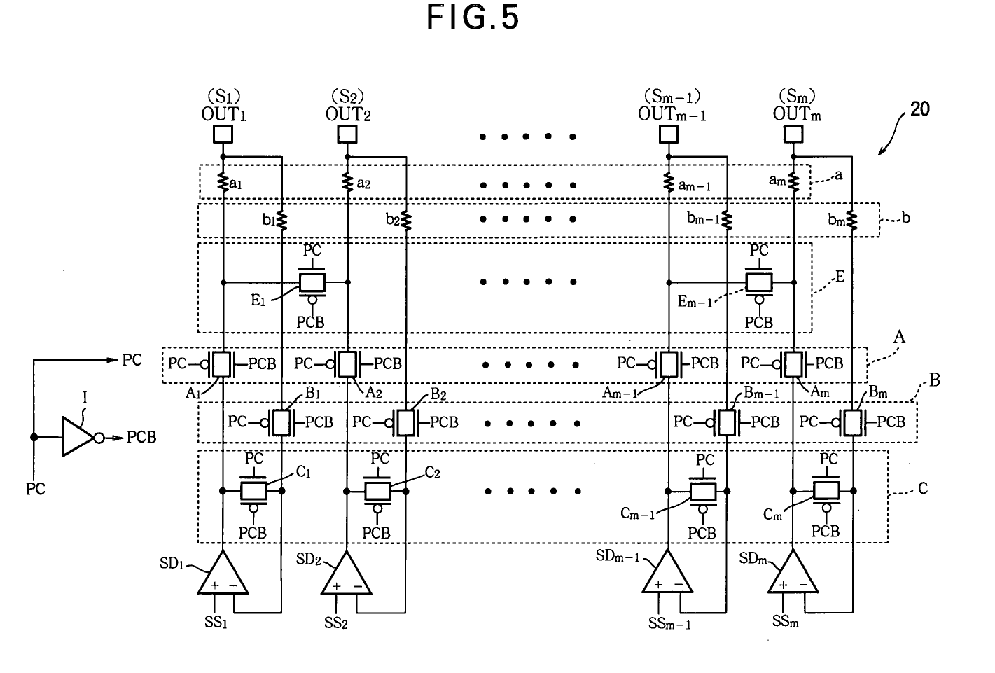

Referring to FIG. 5, the source driving circuit 20 in the second embodiment comprises m source drivers SD₁, SD₂, . . . , SDₘ, an A-group of analog switches that control output paths, a B-group of analog switches that control first feedback paths, a C-group of analog switches that control second feedback paths, an E-group of analog switches that control precharging, an a-group of protective resistors, a b-group of feedback resistors, a group of m output terminals OUT₁, OUT₂, . . . , OUTₘ, and an inverter I, where m is an even number.

The source driving circuit 20 accordingly adds protective resistors and feedback resistors to the source driving circuit 10 in the first embodiment, and alters the group of analog switches that control precharging. The source driving circuit 20 in the second embodiment also arranges the feedback paths during the driving period so that they branch from points following the protective resistors.

The E-group of analog switches comprises m/2 analog switches (MOS switches) E₁, E₃, . . . , Eₘ₋₃, Eₘ₋₁. The i-th analog switch Eᵢ (i being an odd number) interconnects source lines Sᵢ and Sᵢ₊₁ through output terminals OUTᵢ and OUTᵢ₊₁ of the source driving circuit, also being located between analog switches Aᵢ and Aᵢ₊₁; no analog switch is provided to interconnect source lines Sᵢ₊₁ and Sᵢ₊₂ (analog switches Aᵢ₊₁ and Aᵢ₊₂). The number of analog switches in the E-group is therefore half the number of source lines, each analog switch in this group interconnecting two adjacent source lines.

The gate electrode of the PMOS transistor in analog switch Eᵢ receives switch control signal PCB (the output signal from inverter I); the gate electrode of an NMOS transistor in analog switch Eᵢ receives switch control signal PC (the input signal to inverter I). Analog switch Eᵢ turns on if switch control signal PC=1 (PCB=0), thereby establishing a short circuit between source Sᵢ and Sᵢ₊₁ through output terminals OUTᵢ and OUTᵢ₊₁ of the source driving circuit; analog switch Eᵢ turns off if switch control signal PC=0 (PCB=1), thereby breaking the short circuit that has been established between source lines Sᵢ and Sᵢ₊₁ (and between the corresponding output terminals of the source driving circuit).

The a-group of protective resistors comprises m protective resistors a₁, a₂, . . . , aₘ. The i-th protective resistor aᵢ is connected between analog switch Aᵢ and output terminal OUTᵢ (source line Sᵢ) of the source driving circuit 20, and provides protection for analog switch Aᵢ, analog switch Eᵢ or Eᵢ₋₁, and source driver SDᵢ.

The b-group of feedback resistors comprises m feedback resistors b₁, b₂, . . . , bₘ. The i-th feedback resistor bᵢ is connected between analog switch Bᵢ and output terminal OUTᵢ (source line Sᵢ) of the source driving circuit 20, and provides protection for analog switch Bᵢ and source driver SDᵢ.

In the source driving circuit 20 of the second embodiment, source driver SDᵢ, analog switches Aᵢ, Bᵢ, Cᵢ, and Eᵢ, protective resistor aᵢ, feedback resistor bᵢ, and output terminal OUTᵢ form an output circuit.

The operation of the source driving circuit 20 in the second embodiment will be described below with reference to FIG. 3, which shows waveforms of an output signal OUT of the source driving circuit 20 (the signal output from output terminal OUTᵢ to source line Sᵢ), the switch control signal PC and the complementary switch control signal PCB. Td indicates the dot driving cycle time of the liquid crystal display; Tₚ indicates the precharging period.

During a precharging period, switch control signal PC is ‘1’ and switch control signal PCB is ‘0’, so the A- and B-group analog switches are all in the off state, while the C- and E-group analog switches are all in the on state.

Since analog switches Aᵢ and Bᵢ are in the off state and analog switch Eᵢ (or Eᵢ₋₁) is in the on state, output terminal OUTᵢ (source line Sᵢ) is disconnected from the output and inverting input terminals of source driver SDᵢ and is connected via analog switch Eᵢ (or Eᵢ₋₁) to the adjacent output terminal OUTᵢ₊₁ (source line Sᵢ₊₁) or OUTᵢ₋₁ (source line Sᵢ₋₁), thereby being precharged.

Since analog switch Bᵢ is off and analog switch Cᵢ is on, the output potential of source driver SDᵢ is fed back to the inverting input terminal of source driver SDᵢ via analog switch Cᵢ. Since the input impedance of the inverting input of source driver SDᵢ is extremely high, the potential at the inverting input terminal of source driver SDᵢ becomes equal to the output potential of source driver SDᵢ regardless of the on-resistance in analog switch Cᵢ. Since source driver SDᵢ operates so as to make the potential of its inverting input (the output potential of source driver SDᵢ) equal to the potential of its non-inverting input (source driving signal SSᵢ), the output potential of source driver SDᵢ equals the potential of source driving signal SSᵢ.

At the transition from the precharging period to the driving period, switch control signal PC goes to the ‘0’ logic level and switch control signal PCB goes to the ‘1’ logic level, switching all the C- and E-group analog switches off and all the A- and B-group analog switches on.

Analog switch Eᵢ (or Eᵢ₋₁) accordingly turns off and analog switch Aᵢ turns on, disconnecting output terminal OUTᵢ (source line Sᵢ) from the adjacent output terminal OUTᵢ₊₁ (source line Sᵢ₊₁) or OUTᵢ₋₁ (source line Sᵢ₋₁) and connecting it to the output terminal of source driver SDᵢ via analog switch Aᵢ and protective resistor aᵢ.

Analog switch Cᵢ turns off and analog switch Bᵢ turns on, switching from the second feedback path to the first feedback path, thereby feeding back the potential of output terminal OUTᵢ (source line Sᵢ) after the voltage drop caused by the on-resistance of analog switch Aᵢ and the resistance of the protective resistor aᵢ to the inverting input terminal of source driver SDᵢ via analog switch Bᵢ. Since the input impedance at the inverting input terminal of source driver SDᵢ is extremely high, the potential at the inverting input terminal of source driver SDᵢ rapidly becomes equal to the potential of output terminal OUTᵢ (source line Sᵢ) despite the presence of feedback resistor bᵢ. Since source driver SDᵢ operates so as to make the potential of its inverting input (the potential of output terminal OUTᵢ or source line Sᵢ) equal to the potential of its non-inverting input (source driving signal SSᵢ), the potential of output terminal OUTᵢ (source line Sᵢ) rapidly becomes equal to the potential of source driving signal SSᵢ.

At the precharging-to-driving transition, accordingly, the source driving circuit 20 in the second embodiment switches the feedback potential of the i-th output circuit from the potential at a point preceding analog switch Aᵢ to the potential at a point following protective resistor aᵢ, thereby compensating for the voltage drop due to the on-resistance of analog switch Aᵢ and protective resistor aᵢ, so that the potential of output terminal OUTᵢ (source line Sᵢ) quickly becomes equal to the potential of source driving signal SSᵢ (the output potential of source driver SDᵢ). This feedback arrangement also compensates for variations in voltage drop due to variations in the resistance of the protective resistors and the on-resistance of the analog switches, resulting in both faster and more accurate driving of the source lines.

This feedback arrangement can also compensate for the voltage drop due to the resistance of the signal line from the output terminal of source driver SDᵢ to the point at which analog switches Aᵢ and Bᵢ are interconnected, which accounts for most of the wiring resistance on the signal path from the output terminal of source driver SDᵢ to output terminal OUTᵢ. This means that, if there are variations in wiring resistance (or wiring length) on the output paths, they can be compensated for completely, or almost completely, by interconnecting the analog switches Aᵢ and Bᵢ at output terminal OUTᵢ or at a point located as near as possible to output terminal OUTᵢ.

During the driving period, switch control signal PC is ‘0’ and switch control signal PCB is ‘1’, so the A- and B-group analog switches are all in the on state and the C- and E-group analog switches are all in the off state.

Analog switch Eᵢ (or Eᵢ₋₁) is in the off state, and analog switch Aᵢ is in the on state, disconnecting output terminal OUTᵢ (source line Sᵢ) from the adjacent output terminal OUTᵢ₊₁ (source line Sᵢ₊₁) or OUT₁₋₁ (source line Sᵢ₋₁) and connecting it to the output terminal of source driver SDᵢ via analog switch Aᵢ.

Analog switch Cᵢ is in the off state and analog switch Bᵢ is in the on state, feeding the potential of output terminal OUTᵢ (source line Sᵢ) back via feedback resistor bᵢ and analog switch Bᵢ on the first feedback path to the inverting input terminal of source driver SDᵢ, thereby keeping the potential of output terminal OUTᵢ (source line Sᵢ) equal to the potential of the non-inverting input (source driving signal SSᵢ) of source driver SDᵢ.

At the transition from the driving period to the next precharging period, switch control signal PC goes to ‘1’ and switch control signal PCB goes to ‘0’, switching all the A- and B-group analog switches off and all the C- and E-group analog switches on.

Analog switches Aᵢ and Bᵢ turn off and analog switch Eᵢ (or Eᵢ₋₁) turns on, disconnecting output terminal OUTᵢ (source line Sᵢ) from the output and inverting input terminals of source driver SDᵢ, and connecting output terminal OUTᵢ to adjacent output terminal OUTᵢ₊₁ (source line Sᵢ₊₁) or OUTᵢ₋₁ (source line Sᵢ₋₁) via analog switch Eᵢ (or Eᵢ₋₁), thereby precharging source line Sᵢ to the average potential of source line Sᵢ (output terminal OUTᵢ) and the adjacent source line Sᵢ₊₁ or Sᵢ₋₁ (output terminal OUTᵢ₊₁ or OUTᵢ₋₁) during the preceding driving period.

Analog switch Bᵢ turns off and analog switch Cᵢ turns on, switching the feedback path from the first feedback path to the second feedback path, thereby feeding the output potential of source driver SDᵢ back to the inverting input terminal of source driver SDᵢ via analog switch Cᵢ.

As described above, the second embodiment provides a first feedback path from a point following the protective resistor to the source driver during the driving period and a second feedback path from a point preceding the A-group analog switch to the source driver during the precharging period, and switches the feedback path at transitions from the driving period to the precharging period and vice versa, thereby compensating for the voltage drop due to the on-resistance of the analog switch and the resistance of the protective resistor, and further compensating for variations in on-resistance and wiring resistance of the output path. The second embodiment thereby achieves fast and highly accurate liquid crystal driving. The second embodiment also conserves power by precharging each source line from an adjacent source line, and reduces the number of analog switches that control precharging by providing only one such switch for each two source lines.

### Third Embodiment

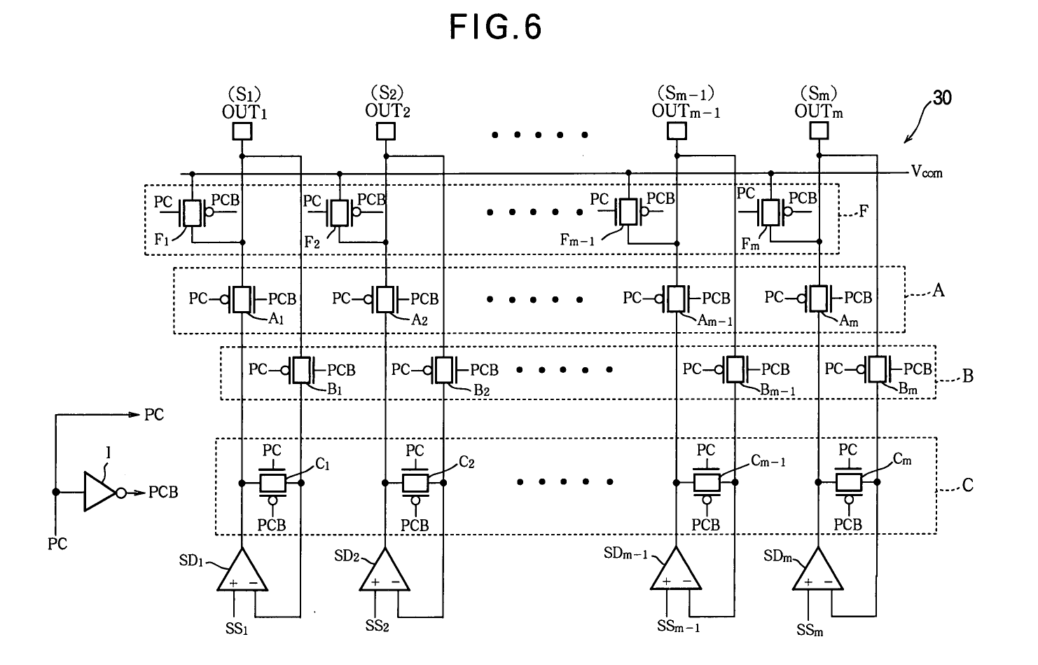

Referring to FIG. 6, the source driving circuit 30 in the third embodiment comprises m source drivers SD₁, SD₂, . . . , SDₘ, an A-group of analog switches that control output paths, a B-group of analog switches that control first feedback paths, a C-group of analog switches that control second feedback paths, an F-group of analog switches that control precharging, a group of m output terminals OUT₁, OUT₂, . . . , OUTₘ, and an inverter I, where m is an arbitrary integer equal to or greater than two.

The source driving circuit 30 in the third embodiment accordingly alters the group of analog switches that control precharging in the source driving circuit 10 (see FIGS. 1 and 2) in the first embodiment.

The F-group of analog switches comprises m analog switches (MOS switches) F₁, F₂, . . . , Fₘ. Analog switch Fᵢ is connected between the i-th output terminal OUTᵢ (source line Sᵢ) of the source driving circuit 30 and the common voltage V_{com} (the potential of the common electrode of the liquid crystal capacitors). The gate electrode of the PMOS transistor in analog switch Fᵢ receives the switch control signal PCB output from the inverter I; the gate electrode of the NMOS transistor in analog switch Fᵢ receives switch control signal PC. Analog switch Fᵢ turns on when PC=1 (PCB=0), thereby connecting output terminal OUTᵢ (source line Sᵢ) to the common voltage V_{com}; analog switch Fᵢ turns off when PC=0 (PCB=1), thereby disconnecting output terminal OUTᵢ (source line Sᵢ) from the common voltage V_{com}. The third embodiment uses the common voltage V_{com} for precharging the source lines (the output terminals of the source driving circuit). The common voltage V_{com} is, for example, half the potential of the power supply voltage supplied to source drivers SD₁ to SDₘ, this being the midpoint potential in the output range of source drivers SD₁ to SDₘ.

In the source driving circuit 30 of the third embodiment, source driver SDᵢ, analog switches Aᵢ, Bᵢ, Cᵢ, and Fᵢ, and output terminal OUTᵢ form an output circuit.

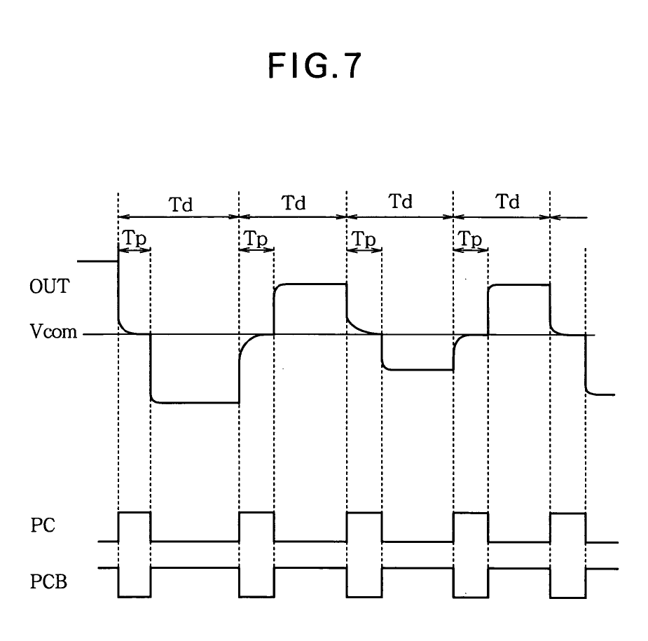

The operation of the source driving circuit 30 in the third embodiment will be described below with reference to FIG. 7, which shows waveforms of an output signal OUT of the source driving circuit 30 (the signal output from output terminal OUTᵢ to source line Sᵢ), the switch control signal PC and the complementary switch control signal PCB. T_{d} indicates the dot driving cycle time of the liquid crystal display; Tₚ indicates the precharging period.

During a precharging period, switch control signal PC (the input signal to inverter I) is ‘1’ and switch control signal PCB (the output signal from inverter I) is ‘0’, so the A- and B-group analog switches are all in the off state, while the C- and F-group analog switches are all in the on state.

Since analog switches Aᵢ and Bᵢ are in the off state and analog switch Fᵢ is in the on state, output terminal OUTᵢ (source line Sᵢ) is disconnected from the output and inverting input terminals of source driver SDᵢ and is connected via analog switches Fᵢ to the common voltage V_{com}, thereby being precharged to the V_{com} potential.

Since analog switch Bᵢ is off and analog switch Cᵢ is on, the output potential of source driver SDᵢ is fed back to the inverting input terminal of source driver SDᵢ via analog switch Cᵢ. Since the input impedance of the inverting input of source driver SDᵢ is extremely high, the potential at the inverting input terminal of source driver SDᵢ becomes equal to the output potential of source driver SDᵢ regardless of the on-resistance in analog switch Cᵢ. Since source driver SDᵢ operates so as to make the potential of its inverting input (the output potential of source driver SDᵢ) equal to the potential of its non-inverting input (source driving signal SSᵢ), the output potential of source driver SDᵢ equals the potential of source driving signal SSᵢ.

At the transition from the precharging period to the driving period, switch control signal PC goes to the ‘0’ logic level and switch control signal PCB goes to the ‘1’ logic level, switching all the C- and F-group analog switches off and all the A- and B-group analog switches on.

Analog switch Fᵢ accordingly turns off and analog switch Aᵢ turns on, disconnecting output terminal OUTᵢ (source line Sᵢ) from the common voltage V_{com} and connecting it to the output terminal of source driver SDᵢ via analog switch Aᵢ.

Analog switch Cᵢ turns off and analog switch Bᵢ turns on, switching from the second feedback path to the first feedback path, thereby feeding back the potential of output terminal OUTᵢ (source line Sᵢ) after the voltage drop caused by the on-resistance of analog switch Aᵢ to the inverting input terminal of source driver SDᵢ via analog switch Bᵢ. Since the input impedance at the inverting input terminal of source driver SDᵢ is extremely high, the potential at the inverting input terminal of source driver SDᵢ rapidly becomes equal to the potential of output terminal OUTᵢ (source line Sᵢ) regardless of the on-resistance of analog switch Bᵢ. Since source driver SDᵢ operates so as to make the potential of its inverting input (the potential of output terminal OUTᵢ or source line Sᵢ) equal to the potential of its non-inverting input (source driving signal SSᵢ), the potential of output terminal OUTᵢ (source line Sᵢ) rapidly becomes equal to the potential of source driving signal SSᵢ.

At the precharging-to-driving transition, accordingly, the source driving circuit 30 in the third embodiment switches the feedback potential of the i-th output circuit from the potential at a point preceding analog switch Aᵢ to the potential at a point following analog switch Aᵢ, thereby compensating for the voltage drop due to the on-resistance of analog switch Aᵢ so that the potential of output terminal OUTᵢ (source line Sᵢ) quickly becomes equal to the potential of source driving signal SSᵢ (the input potential to source driver SDᵢ). This feedback arrangement also compensates for variations in voltage drop due to variations in on-resistance, resulting in both faster and more accurate driving of the source lines.

This feedback arrangement can also compensate for the voltage drop due to the resistance of the signal line from the output terminal of source driver SDᵢ to the point at which analog switches Aᵢ and Bᵢ are interconnected, which accounts for most of the wiring resistance on the signal path from the output terminal of source driver SDᵢ to output terminal OUTᵢ. This means that, if there are variations in wiring resistance (or wiring length) on the output paths, they can be compensated for completely, or almost completely, by interconnecting the analog switches Aᵢ and Bᵢ at output terminal OUTᵢ or at a point located as near as possible to output terminal OUTᵢ.

During the driving period, switch control signal PC is ‘0’ and switch control signal PCB is ‘1’, so the A- and B-group analog switches are all in the on state and the C- and F-group analog switches are all in the off state.

Analog switch Fᵢ is in the off state, and analog switch Aᵢ is in the on state, disconnecting output terminal OUTᵢ (source line Sᵢ) from the common voltage V_{com} and connecting it to the output terminal of source driver SDᵢ via analog switch Aᵢ.

Analog switch Cᵢ is in the off state and analog switch Bᵢ is in the on state, feeding the potential of output terminal OUTᵢ (source line Sᵢ), which is the output potential of source driver SDᵢ minus the voltage drop due to the on-resistance of analog switch Aᵢ, back via analog switch Bᵢ to the inverting input terminal of source driver SDᵢ, thereby keeping the potential of output terminal OUTᵢ (source line Sᵢ) equal to the potential of the non-inverting input (source driving signal SSᵢ) of source driver SDᵢ.

At the transition from the driving period to the next precharging period, switch control signal PC goes to ‘1’ and switch control signal PCB goes to ‘0’, switching all the A- and B-group analog switches off and all the C- and F-group analog switches on.

Analog switches Aᵢ and Bᵢ turn off and analog switch Fᵢ turns on, disconnecting output terminal OUTᵢ (source line Sᵢ) from the output and inverting input terminals of source driver SDᵢ, and connecting output terminal OUTᵢ to the common voltage V_{com}, thereby precharging source line Sᵢ to the V_{com} potential.

Analog switch Bᵢ turns off and analog switch Cᵢ turns on, switching from the first feedback path to the second feedback path, thereby feeding the output potential of source driver SDᵢ back to the inverting input terminal of source driver SDᵢ via analog switch Cᵢ.

As described above, the third embodiment provides a first feedback path from a point following the A-group analog switch to the source driver during the driving period and a second feedback path from a point preceding the A-group analog switch to the source driver during the precharging period, and switches the feedback path at transitions from the driving period to the precharging period and vice versa, thereby compensating for the voltage drop due to the on-resistance of the analog switch in the driving period, and further compensating for variations in on-resistance and wiring resistance of the output path. The third embodiment thereby achieves fast and highly accurate liquid crystal driving.

Those skilled in the art will recognize that many modifications can be made to the above embodiments within the scope of the invention, which is defined in the appended claims.

1. An output circuit having an impedance conversion element generating an output signal from an input signal and a feedback signal, and an output path that conducts the output signal from the impedance conversion element to an output terminal, the output circuit also comprising:
a first switch disposed on the output path, for conducting the output signal during an output period and blocking the output signal during a non-output period;
a second switch for conducting the output signal from a first point on the output path to the impedance conversion element as the feedback signal during the output period, the first point being disposed at the output terminal or between the first switch and the output terminal; and
a third switch for conducting the output signal from a second point on the output path to the impedance conversion element as the feedback signal during the non-output period, the second point being disposed between the impedance conversion element and the first switch.

2. The output circuit of claim 1, further comprising:
a protective resistor connecting the first point to the first switch; and
a feedback resistor connecting the first point to the second switch.

3. The output circuit of claim 1, further comprising a fourth switch for connecting the output terminal to a fixed power supply during the non-output period.

4. The output circuit of claim 1, wherein the impedance conversion element is an operational amplifier having an inverting input terminal for receiving the feedback signal.

5. The output circuit of claim 1, wherein the first, second, and third switches are analog switches controlled by a switch control signal, the first and second switches being turned on when the switch control signal is at a first logic level and being turned off when the switch control signal is at a second logic level, the third switch being turned off when the switch control signal is at the first logic level and being turned on when the switch control signal is at the second logic level.

6. A liquid crystal driving circuit for driving a liquid crystal panel, the liquid crystal driving circuit comprising a plurality of output circuits as described in claim 1, the liquid crystal panel having a plurality of signal lines connected to the output terminals of the driving circuits, the impedance conversion element of each output circuit thus functioning as a signal line driver.

7. The liquid crystal driving circuit of claim 6, further comprising at least one fourth switch for interconnecting said signal lines during the non-output period.

8. The liquid crystal driving circuit of claim 6, further comprising at least one fourth switch for interconnecting a mutually adjacent pair of said signal lines during the non-output period.

9. The liquid crystal driving circuit of claim 6, further comprising a plurality of fourth switches for connecting said signal lines to a fixed power supply during the non-output period.

10. A method of driving a liquid crystal panel having a plurality of signal lines by using a plurality of drivers generating respective output signals from respective input signals and respective feedback signals, the method comprising:
connecting the drivers to a plurality of output terminals to which said signal lines are connected, thereby using the output signals of the drivers to drive said signal lines, and returning the output signals from the output terminals to the drivers as said feedback signals; and
disconnecting the drivers from the output terminals and precharging said signal lines while using the output signals of the drivers as said feedback signals.

11. The method of claim 10, wherein precharging said signal lines comprises interconnecting said signal lines.

12. The method of claim 10, wherein precharging said signal lines comprises interconnecting mutually adjacent pairs of said signal lines.

13. The method of claim 10, wherein precharging said signal lines comprises connecting said signal lines to a fixed power supply.
